(19) United States
(12) Patent Application Publication
(10) Pub. No.: US 2007/0082539 A1
(43) Pub. Date: Apr. 12, 2007

(54) Insulation displacement connection for securing an insulated conductor

(76) Inventor: Slobadan Pavlovic, Canton, MI (US)

Correspondence Address: MACMILLAN, SOBANSKI & TODD, LLC, ONE MARITIME PLAZA-FIFTH FLOOR, 720 WATER STREET, TOLEDO, OH, 43604, US

(21) Appl. No.: 11/248,043

(22) Filed: Oct. 12, 2005

(51) Int. Cl. H01R 4/24

(52) U.S. Cl. 439/400

(57) ABSTRACT

A connector for engaging a conductor enclosed by insulation includes a housing including a base, the housing having a slot directed toward the base, a throat whose width is less than a width of an outer surface of the insulation, and a retention recess communicating with the throat and having a width that is greater than the width of the throat, for engaging the conductor after the conductor passes along the first slot through the first throat into the first retention recess.

### BACKGROUND OF THE INVENTION

The present invention relates to a connector that produces an electrical connection with an insulated lead by displacing insulation surrounding a conductor and securing the lead against displacement relative to the connector. More particularly the invention pertains to such a connector for use in the electrical system of a motor vehicle.

Insulation displacement connection (IDC) is a technique employing a connector that engages the insulation surrounding an electrical conductor in order to secure the conductor to the connector. Conductor strain relief provides vertical conductor position assurance in the IDC holding the conductor in place to prevent movement of the conductor relative to the IDC interface and potential interface damage. It also improves conductor pull force performance by cutting into the insulation when the conductor is pulled vertically or longitudinally.

Conventional connectors in the prior art usually include strain relief and position definition features integrated into a mating part. These features often are in the form of bumps on a plastic connector cover, housing or another part of the connector. The bumps are used to form and IDC interface by pushing conductor into the IDC. But such connectors rely on the dimensional tolerance between the mating parts and positive mechanical locks to secure the parts mutually. Reliance on dimensional tolerances and mechanical locking permits great variability in the position of the conductor relative to the IDC interface and affects quality of the IDC interface.

It is preferable that an IDC rely instead on mechanical engagement with the conductor insulation to provide repeatable positioning of the conductor relative to the connector and to prevent displacement of the conductor relative to the connector, especially displacement resulting from conductor pulling forces, which is an important requirement of IDC performance.

### SUMMARY OF THE INVENTION

An IDC according to the present invention secures the position of the conductor relative to the connector by positively engaging the insulation surrounding the conductor bundle. This feature prevents potential damage to the conductor that would occur if its position were not fixed. It also improves conductor pull force performance by cutting into the insulation when conductor is pulled vertically or longitudinally away from the connector.

A connector according to this invention provides at least two axially spaced slots having a transition length, whose width varies along its length, and a narrow throat, whose width is substantially smaller than the diameter of the conductor's insulation. Therefore, the slot engages the conductor with an interference fit as the conductor is pushed into the IDC interface. Further along the length of the slot, its width increases into a larger diameter recess having a hook-like shape that restrains the conductor in the IDC box when the conductor is inserted in and secured to the connector.

When a conductor is being inserted into the connector, the conductor's insulation is compressed against the sides of the slot due to its being loaded laterally against the slot. After passing the narrow throat of each slot, the conductor's insulation expands radially outward to produce preload interference contact with the retention or locking recess of the slot, thereby pushing conductor into the IDC interface. Edges of the slots can be sharp enough to partially penetrate into the insulation, thereby providing a lock that resists lateral movement of the conductor in the IDC.

An IDC according to this invention ensures better repealatchility of conductor-to-IDC position. Additional strain on the insulation prevents conductor movement in the IDC interface and provides additional conductor pull resistance, a critical performance advantage for an IDC.

When conductors are pulled vertically or longitudinally in a direction that would remove the conductors from the IDC, this removal is prevented by the IDC cutting into the insulation, retaining the conductor in the IDC, thereby making the IDC interface more robust and resistant to mechanical loads.

A connector, according to this invention, for engaging a conductor enclosed by insulation includes a housing including a base, the housing having a first slot directed toward the base, the slot formed with a throat whose width is less than a width of an outer surface of the insulation, and a retention recess communicating with the throat and having a width that is greater than the width of the throat, for engaging the conductor after the conductor passes along the slot through the throat into the retention recess.

### DESCRIPTION OF THE DRAWINGS

The above, as well as other advantages of the present invention, will become readily apparent to those skilled in the art from the following detailed description of a preferred embodiment when considered in the light of the accompanying drawings in which:

FIG. 1 is a perspective view of a conductor located above a connector according to this invention and before its insertion into the connector slots,

FIG. 2 is a perspective view of a conductor secured to the connector of FIG. 1;

FIG. 3 is a top view of the connector showing the conductor installed in the connector slots;

FIG. 4 is a cross section taken at plane 4-4 in FIG. 3; and

FIG. 5 is an end view of the connector with the conductor installed in the recesses.

### DESCRIPTION OF THE PREFERRED EMBODIMENT

Referring to the figures, an electrical connector 10 for securing a conductor 12 of insulated wire to the connector includes a rectangular box having a base, an open top, and four vertical walls 14, 16, 18, 20—two axial walls 14, 18 spaced mutually along the length of the conductor, and two lateral walls 16, 20 spaced mutually on opposite lateral sides of the conductor. The conductor 12 may include a single wire or a bundle of wires 24. In neither case, the conductor 12 is enclosed by a sheath of insulation material 22, which is usually in the form of a circular cylinder, preferably of plastic or another resilient material. The connector is formed of electrically conductive metal, preferably a copper alloy such as 5100 or beryllium copper.

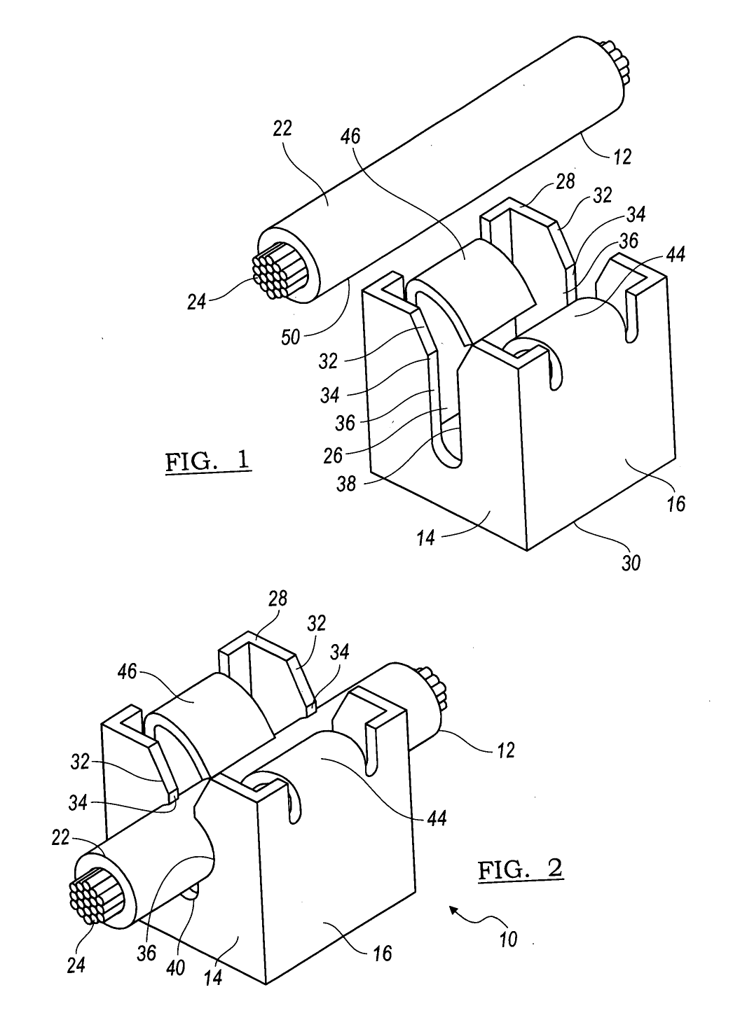

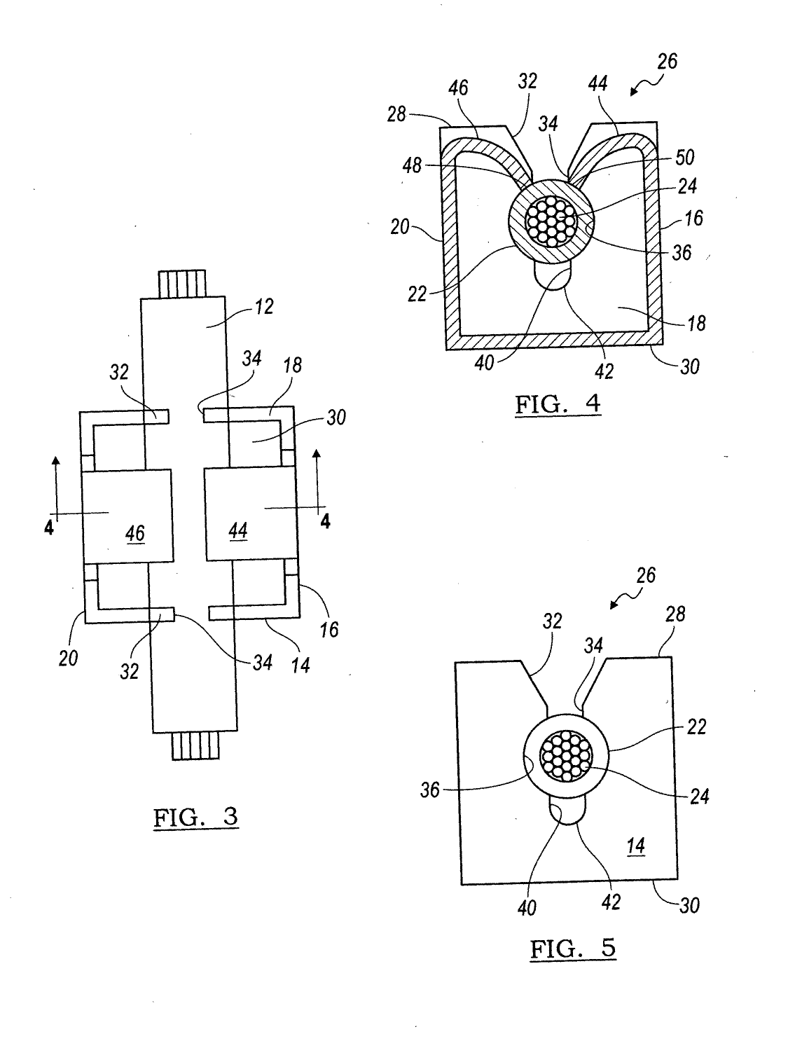

Each of the axial walls 14, 18 is formed with a slot 26 directed generally downward from the upper surface 28 toward the base 30, which closes the box at its lower extremity. Each slot 26 is formed through the thickness of an axial wall and includes an upper tapered transition portion 32, whose width decreases as distance along the slot 26 from the upper surface 28 toward the base 30 increases. At the lower end of the transition 32, each slot 26 includes a throat 34, whose width is less than the outer diameter of the insulation 22 and less than the diameter of the bundle of wires 24 before installing the conductor 12 in the connector 10. Below the throat 34, the lateral surfaces 36, 38 of each slot 26 extend toward the base 30 and terminate in a semi-circular radius 42. As the conductor 12 is inserted in the connector 10, the insulation 24 is cut by the throat 34, and the sides 36, 38 of the slot compress the wires 24 laterally, thereby producing an elastic, electrically-conductive, interference contact between the wires and the connector slot. FIG. 1 shows the connector 10 disposed to receive the conductor 12 in the transition portion 32 of the slots 26 and before inserting the conductor in the slots. In this condition, latches 44, 46, which are formed integrally with the lateral walls 16, 18, respectively, are bent laterally inward forming two arches that are spaced laterally, as seen best in FIG. 3. The lateral space between the latches 44, 46 provides the conductor 12 a path of access to the throat 34 and the slots 26.

Installation of the conductor 12 in connector 10 begins by placing the conductor on the transition portions 32, forcing the conductor downward against the latches 44, 46, deflecting and passing the conductor between the latches, passing the conductor through the throats 34, and moving the conductor downward along the slots 26 to the position illustrated in FIG. 5. The conductor 12 is forced in this way into the slots in both axial walls 14, 18. As the conductor 12 enters and passes through the throats 34, the insulation 22 is compressed and cut locally at each throat by its interference with edges of the throat 34, and the wire 24 contacts the slot surfaces, thereby bringing the wire 24 into direct contact with the sides 36, 38 of the slots. After the conductor 12 passes through the throats 34 and cuts are made through the thickness of the insulation, the length of the insulation 22 and wires 24 that is spaced along the conductor from the slots expands radially outward from the compressed condition to the generally circular cylindrical shape shown in FIGS. 2, 4 and 5.

After the conductor 12 reaches its proper position in the slots 26, represented in FIG. 4, the latches 44, 46 are in contact with the outer surface of the conductor, thereby limiting or preventing outward radial movement the conductor 12 relative to the connector 10. Each slot is located within an incision through the insulation, thereby limiting or preventing longitudinal movement the conductor 12 relative to the connector 10.

A conductor according to this invention ensures excellent repeatability of the conductor-to-connector position. Additional strain on the insulation prevents conductor movement in the connector and provides additional conductor pull resistance, a critical performance advantage for a connector.

When the conductor is are pulled vertically or longitudinally in a direction that would remove the conductor from the connector, this removal is prevented by the connector cutting into the insulation, retaining the conductor in position, thereby making the connector more robust and resistant to mechanical loads.

In accordance with the provisions of the patent statutes, the present invention has been described in what is considered to represent its preferred embodiment. However, it should be noted that the invention can be practiced otherwise than as specifically illustrated and described without departing from its spirit or scope.

1. A connector for engaging a conductor that includes wire and insulation covering the wire, comprising:
a housing including a base;
a first slot whose length is directed toward the base, the first slot having a first throat whose width is less than a width of a radial outer surface of the insulation and engageable with the wire of the conductor,
a second slot Spaced axially from the first slot, directed toward the base, the second slot having a second throat whose width is less than a width of a radial outer surface of the insulation and engageable with the wire of the conductor;
a first latch secured to the housing and including a first surface inclined toward the bas, and a second surface located at an end of the first latch and contact an outer surface of the insulation when the conductor is located in the first slot and the second slot; and
a second latch secured to the housing and including a third surface inclined toward the base, and a fourth surface located at an end of the second latch and contacting an outer surface of a length of the insulation when the conductor is located in the first and second slots, the second surface and fourth surface located between the first slot and second slot and located such that a length of the conductor that extends between the first slot and second slot is axially straight and without lateral displacement due to contact with the second surface and the fourth surface.

2. The connector of claim 1 wherein the first slot further includes a first transition recess communicating with the first throat, having a length directed toward the first throat, and a width that decreases as distance along the length of the first slot toward the first throat increases.

3. (canceled)

4. The connector of claim 1 wherein the second slot further includes a second transition portion communicating with the second throat, and having a length directed toward the second throat and a width that decreases as distance along the length of the second slot toward the second throat increases.

5. (canceled)

6. A connector for engaging a conductor that includes wire and insulation covering the wire, comprising:
a housing including a base;
a first wall extending from the base, the first wall having a first slot directed toward the base, the first slot being formed with a throat spaced from the base and having a width that is less than a width of a outer surface of the insulation and engageable with the wire of the conductor;
a second wall extending firm the base and spaced axially from the first wall, the second wall having a second slot directed toward the base and formed with a second throat whose width is less than a width of a outer surface of the insulation and engageable with the wire of the conductor;
a third wall extending axially between the first wall and second wall, formed with a first latch that includes a first surface inclined toward the base, and a second surface located at an end of the first latch and contacting an outer surface of the insulation when the conductor is located in the first slot and the second slot; and
a fourth third wall spaced laterally from the third wall and extending axially between the first wall and second wall, formed with a second latch that includes a first surface inclined toward the base, and a second surface located at an end of the second latch and contacting an outer surface of the insulation when the conductor is located in the first slot and the second slot, the second surface and fourth surface located between the first wall and second wall and located such that a length of the conductor that extends between the first slot and second slot is axially straight and without lateral displacement due to contact with the second surface and the fourth surface.

7. The connector of claim 6 wherein the first slot further includes a first transition portion communicating with the first throat, having a length directed toward the first throat, and a width that decreases as distance along the length of the first slot toward the first throat increases.

8. (canceled)

9. The connector of claim 8 wherein:
the first slot further includes a first transition portion communicating with the first throat, having a length directed toward the first throat, and a width that decreases as distance along the length of the first slot toward the fist throat increases; and
the second slot further includes a second transition portion communicating with the second throat, having a length directed toward the second throat, and a width that decreases as distance along the length of the second slot toward the second throat increases.

10. The connector of claim 8, wherein:
the third wall extends from the base and is secured to the first wall and the second wall, the first latch being secured to the third wall for guiding the conductor into the first slot and second slot as the conductor is inserted into the housing; and
the fourth wall extends from the base, is secured to the first wall and second wall, and the second latch guides the conductor into the first slot and second slot as the conductor is inserted into the housing.

11. A connector for engaging a conductor that includes wire and insulation covering the wire, comprising:
a housing including a base;
a first wall extending from the base, the first wall having a first slot directed toward the base, the first slot being formed with a throat spaced from the base and having a width is less than a width of the outer surface of the insulation and engageable with the wire of the conductor, and a first transition portion communicating with the first throat, having a length directed toward the first throat, and a width that deceases as distance along the length of the first slot toward the first throat increases;
a second wall extending from the base and spaced from the first wall along a length of the conductor, the second wall having a second slot directed toward the base, the second slot being formed with a second throat whose width is less than a width of the outer surface of the insulation and engageable with the wire of the conductor, and a second transition portion communicating with the second throat, having a length directed toward the second throat, and a width that decreases as distance along the length of the second slot toward the second throat increases;
a first latch secured to the housing and including a first surface inclined toward the base and along the first and second slots, for guiding the conductor into the first and second slots as the conductor is inserted into the housing, and a second surface located at an end of the first latch and contacting an outer surface of the insulation when the conductor is located in the first and second slots; and
a second latch secured to the housing and including a third surface inclined toward the base and along the first and second slots, for guiding the conductor into the first and second slots as the conductor is inserted into the housing, and a fourth surface located at an end of the second latch and contacting the insulation when the conductor is located in the first and second slots, the second surface and fourth surface located between the first wall and second wall and located such that a length of the conductor that extends between the first slot and second slot is axially straight and without lateral displacement due to contact with the second surface and the fourth surface.

12. The connector of claim 11, further comprising:
a third wall extending from the base and secured to the first wall and the second wall, the fist latch being supported on the third wall; and
a fourth wall extending from the base, secured to the first wall and second wall, and spaced laterally from the third wall, the second latch being supported on the fourth wall.
